(19) United States
(12) Patent Application Publication
(10) Pub. No.: US 2018/0325072 A1
(43) Pub. Date: Nov. 15, 2018

(54) CHEESE BLOCKFORMER AND SCREEN

(71) Applicant: RELCO LLC, Willmar, MN (US)

(72) Inventor: Darin Fischer, Willmar, MN (US)

(21) Appl. No.: 15/977,899

(22) Filed: May 11, 2018

Related U.S. Application Data
(60) Provisional application No. 62/505,716, filed on May 12, 2017.

(51) Int. Cl. A01J 25/11; A01J 25/12

(52) U.S. Cl. CPC A01J 25/112; A01J 25/12

(57) ABSTRACT

A screen for a cheese blockformer is disclosed, the screen includes a metal sheet having a vertical orientation and a plurality of openings in the metal sheet. In certain examples, the openings each comprise a perforation. The screen can be constructed to be readily removable from the blockformer column and can be secured with an interlocking flange construction at the upstream end of the screen. Certain constructions are directed to a cheese blockformer comprising a tower having a plurality of walls, each wall having an interior side that faces an interior volume of the tower; a screen disposed inside the tower and a plurality of openings in the screen, each opening comprising a perforation and a dimple, the dimple being disposed on the exterior surface of the screen.

### FIELD OF THE INVENTION

The present disclosure relates to cheese blockformers, in particular blockformers with improved screens.

### BACKGROUND

Blockformers are machines for production large blocks of cheese, typically 40 to 60 pounds, from stirred or milled and salted cheese curd. These blockformers include a tower section for receiving and holding curd under vacuum and a base assembly for forming and ejecting a block of cheese. The towers include one or more perforated metal sheets that allows for drainage of whey from the curd under vacuum. These perforated metal sheets are referred to herein as “screens”, and are positioned on all four interior surfaces of the tower which face the cheese on the interior of the blockformer tower. Thus, blockformers have tower columns holding the cheese to be formed into a block, are required to have some functionality for air removal and whey drainage, typically by way of a vacuum applied to a screen.

Blockformers were initially developed in the 1970's and include a rectangular vacuum chamber, generally about eighteen feet tall containing screens of light gage steel. The screens had punched rectangular openings for the drainage of whey and removal of air. The chambers operated primarily under varying vacuum levels for achieving the curd forming process to make solid homogeneous blocks.

Over the years manufacturers developed various screen constructions and configurations. The variations included screens of rigid construction with rectangular or round holes of various depth profiles. Many designs evolved to have fewer numbers of holes with less overall open area. Many screen constructions were designed to be a fixed and integral part of the tower column and are not replaceable. Further, many screens were designed with thinner gage metal, although such designs were prone to cracking and physical deformation.

### SUMMARY

A need remains for an improved screen that has adequate strength to maintain the force from cheese under vacuum, maintain an air gap behind the screen, withstand the flexing loads, and be able to remove air and whey effectively under process conditions. This functionality, in combination, is necessary to have the cheese curd knit as early as possible in the block forming process. In addition, the design should maintain low friction characteristics between the cheese and the interior surface of the screen.

A screen is disposed inside the tower. The screen is typically substantially parallel with the interior wall of the column, the screen having an exterior side facing the wall of the tower column and an interior side facing the inner volume of the tower column. A gap is formed between the screen and the walls of the tower column, and in operation a vacuum is drawn within this gap between the screen and the tower column. A plurality of openings is located in the screen and allow whey to drain from the curd. At least some of the openings typically comprise a vertically or included oriented perforation and a dimple, the dimple being disposed on the exterior surface of the screen. The construction allows for rapid and efficient removal of whey from the curd, provides a low-resistance surface for flow of the curd, preserves the strength of the screen, and assists in maintaining a gap between the screen and interior of the tower column wall. This gap typically runs around the perimeter of the column and is a narrow annular space intermediate the screen and the column walls. A vacuum can be applied to this space to draw air and whey through the screen, into the gap, and out of the column.

Thus, a punched stainless steel screen for removing whey from curd in a cheese blockformer is disclosed. The screen can use dimples, also referred to herein as louvers or thumbnail louvers, placed at offset diagonal position. The open area per unit area combined with the relative opening frequency of the screen is higher than prior art screens. In some constructions of this design, as the cheese slides downward in the column of the blockformer, all face area of the cheese in contact with the screen on its travel sees exposure to the thumbnail openings in multiple frequency. Optionally small holes are placed at intervals for increased performance. The shape and orientation of the louvers improves strength so that pieces of the screen do not fatigue and break off into the product. The location and size of the louvers decreases static friction, making the cheese less likely to adhere to the sides of the screen. The improved screens are also less prone to physical deformation under vacuum.

More specifically, as noted above, the screen further comprises, in some constructions, a raised dimple or louvre corresponding to at least some of the openings in the screen. The raised dimple forms, for example, the back of a hemispherical perforation. The hemispherical perforations can form a substantially straight side and a substantially curved side, the straight side forming a break in the metal sheet, the curved side forming a continuous connection with the metal sheet. Typically, the hemispherical perforation is oriented such that a straight side is positioned in a substantially vertical orientation. As discussed further below, the dimple or louver can form an inclined surface down at the upstream side of the dimple or louver, and an inclined surface up at the downstream side of the louvre (upstream and downstream referring to the direction of curd flow). Also, in certain constructions, the hemispherical perforation has a vertical edge, but does not have a horizontal downstream or upstream edge.

The hemispherical perforation is often substantially semicircular or otherwise is a partial circle. Optionally the screen contains additional circular holes disposed in the metal sheet between the hemispherical perforations. In some constructions, the plurality of hemispherical perforations is arranged in a regular pattern having a horizontal repeat width of, for example, 0.36 inches. The plurality of hemispherical perforations is arranged in a regular pattern can have a vertical repeat height of, for example, 1.24 inches. Each hemispherical perforation has, in some embodiments, a width of about, for example, 0.31 inches. In some implementations, the plurality hemispherical perforations have a perforation width, the spaced relationship of the openings has a vertical spacing interval, and wherein the vertical spacing interval is smaller than the perforation width. The plurality of hemispherical perforations can be arranged in a diagonal pattern having a slope of, for example, 23 degrees. The plurality of hemispherical perforations has a density of 1 percent of the screen surface, or about 0.009 square inches per square inch of screen in some configurations. In other embodiments the perforations comprise from 0.5 percent to 2 percent of the screen surface. In some a screen for a cheese blockformer, the screen can include a metal sheet having a thickness of between 0.036 inches and 0.315 inch.

The present application is also directed to a cheese blockformer comprising a tower having a plurality of walls, each wall having an interior side that faces an interior volume of the tower; a first screen disposed inside the tower and parallel with the interior side of a first wall from among the plurality of walls, the screen having an exterior side facing the interior side of the first wall and an interior side facing the interior volume of the tower; and a plurality of openings in the screen, each opening comprising a vertical perforation and a dimple, the dimple being disposed on the exterior surface of the screen.

This equipment is designed to operate in food/dairy processing facilities, and in such facilities, food sanitation design features are important to consider. Typical of these regulations are the 3—A standards for hygienic equipment design and fabrication, certified by 3—A Sanitary Standards, Inc. of McLean, Va., USA. A specific standard for cheese blockformer screens and towers does not yet exist, however, complying with 3—A standards in general is advantageous.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense.

### BRIEF DESCRIPTION OF THE DRAWINGS

FIG. 1 is a perspective view of a cheese blockformer machine.

FIG. 2 is a front elevational view of the tower column of a cheese blockformer.

FIG. 3 is a side elevational view of the tower column of a cheese blockformer.

FIG. 4 is a front cross sectional view of the top portion of a tower column of a cheese blockformer constructed and arranged in accordance with an implementation of the present disclosure.

FIG. 5 is an enlarged side cross sectional view of a portion of a tower column of the cheese blockformer of FIG. 4.

FIG. 6 is a top view of a flange for securing a cheese tower column to a base.

FIG. 7 is a perspective view of a tower column of a cheese blockformer.

FIG. 8 is a perspective view of a two-sided screen for a tower column of a cheese blockformer constructed and arranged in accordance with an implementation of the present disclosure.

FIG. 9A is an elevational view of a first side of a two-sided screen for a tower column of a cheese blockformer constructed and arranged in accordance with an implementation of the present disclosure.

FIG. 9B is an elevational view of a second side of the two-sided screen for a tower column of a cheese blockformer of FIG. 9A, constructed and arranged in accordance with an implementation of the present disclosure.

FIG. 10A is an elevational view of a perforated portion of a screen for a tower column of a cheese blockformer.

FIG. 10B is an elevational view of an alternative example of a perforated portion of a screen for a tower column of a cheese blockformer.

FIG. 11A is a side elevational view of an opening in a screen for a tower column of a cheese blockformer.

FIG. 11B is a perspective view of the opening of FIG. 11A.

FIG. 12A is a side cross-sectional view of a perforation in a screen for a tower column of a cheese blockformer.

FIG. 12B is a side elevation view of an alternative example of an opening in a screen for a tower column of a cheese blockformer.

FIG. 12C is a cross-sectional view taken along line C-C of the alternative example of FIG. 12B.

FIG. 12D is a bottom view of the alternative example of FIG. 12B.

FIG. 12E is a side elevation view of another alternative example of an opening in a screen for a tower column of a cheese blockformer.

FIG. 12F is a cross-sectional view taken along line F-F of the alternative example of FIG. 12E.

FIG. 12G is a bottom view of the alternative example of FIG. 12E.

FIG. 12H is a perspective view of the alternative example of FIG. 12E.

FIG. 13A is an elevational view of a screen for a tower column of a cheese blockformer, before the screen is folded into an approximately 90-degree angle.

FIG. 13B is an elevational view of a first side of the two-sided screen for a tower column of a cheese blockformer of FIG. 13A constructed and arranged in accordance with an implementation of the present disclosure.

FIG. 13C is an elevational view of a second side of the two-sided screen for a cheese blockformer of FIG. 13A, constructed and arranged in accordance with an implementation of the present disclosure.

FIG. 14 is a closeup of the top of a screen for a tower column of a cheese blockformer.

Unless indicated, the various figures are not necessarily drawn to scale. While examples herein are susceptible to various modifications and alternative forms, specifics thereof have been shown by way of example and drawings, and will be described in detail. It should be understood, however, that the scope herein is not limited to the examples described. On the contrary, the intention is to cover modifications, equivalents, and alternatives falling within the spirit and scope herein.

### DETAILED DESCRIPTION

The present application is directed to a screen for a cheese blockformer, plus a blockformer column containing the screen. The screen includes a metal sheet having a vertical orientation and plurality openings in the metal sheet. In some examples, the openings each comprise a hemispherical perforation. In alternative examples, the openings each comprise a perforation defining an internal opening angle. The screen can be constructed to be readily removable from the blockformer column, and can be secured with an interlocking flange construction at the upstream end of the screen.

Certain constructions are directed to a cheese blockformer comprising a tower column having a plurality of walls, each wall having an interior side that faces an interior volume of the tower column. In some examples, the tower column is four-walled. A screen is disposed inside the tower and parallel with the interior side of a first wall from among the plurality of walls, the screen having an exterior side facing the interior side of the first wall of the tower column and an interior side facing the interior volume of the tower. A gap is formed between the screen and the walls of the tower column, and in operation a vacuum is drawn within this gap between the screen and the tower column to transport air and whey from the interior volume of the tower into the gap and away from the curd. A plurality of openings located in the screen allow air and whey to drain from the curd. In some examples, at least some of the openings comprise a perforation and a dimple, the dimple being disposed on the exterior side of the screen. In some examples, the perforation is vertically oriented with respect to the flow of curd. In alternative examples, the perforation is non-vertically oriented. The construction allows for rapid and efficient removal of air and whey from the curd, provides a low-resistance surface for flow of the curd, preserves the strength of the screen, and assists in maintaining a gap between the screen and interior of the tower column wall. This gap runs around the perimeter of the column and is a narrow annular space intermediate the screen and the column walls. A vacuum can be applied to this space to draw air and whey through the screen, into the gap, and out of the column.

Thus, a punched stainless steel screen for removing air and whey from curd in a cheese blockformer is disclosed. The screen uses dimples, also referred to herein as louvers, placed at offset diagonal positions. The area of the openings per unit area of screen and the relative frequency of the openings is higher than prior art screens. As the cheese slides downward vertically in the column of the blockformer, all or substantially all of the cheese that is in contact with the screen on its travel down the height of the tower encounters multiple openings in the screen. In some examples, additional small holes in the screen are placed at intervals for increased whey and air removal under vacuum.

The shape and orientation of the dimples improves the strength of the openings so that pieces of the screen do not fatigue and break off into the product. The location and size of the dimples decreases static friction, making the cheese less likely to adhere to the side surfaces of the screen. Alternatively the dimples can be referred to as louvers. The improved screens are also less prone to cracking and physical deformation under vacuum. Thus, the improved screen provides beneficial levels of structure, open area, opening distribution, and surface release characteristics.

More specifically, as noted above, the screen further comprises a raised dimple or louvre corresponding to at least some of the openings in the screen. In some examples, the raised dimple is formed in connection with a perforation to form the openings in the screen. In some examples, the perforations are hemispherical, and these hemispherical perforations can form a substantially linear edge and a substantially curved edge, the straight edge forming a break in the metal sheet, the curved edge forming a continuous connection with the metal sheet. In alternative examples, the perforation defines an internal angle of the opening in the screen.

In some examples, the perforation is oriented in a substantially vertical orientation aligned with the flow of curd. In alternative examples, the perforation is oriented in a non-vertical orientation, at an angle with respect to the flow of curd. The dimple or louver can form a first inclined surface at the upstream side of the dimple or louver, and a second inclined surface at the downstream side of the louver (upstream and downstream referring to the direction of curd flow), where the first inclined surface is inclined away from the interior surface of the screen, and the second inclined surface is inclined toward the interior surface of the screen.

In some examples the dimple is substantially semicircular or otherwise is a partial circle. In alternative examples, the dimple defines a perimeter that includes straight or linear sides. In some examples, the screen contains additional circular openings disposed in the metal sheet between the perforations.

In some constructions, the plurality of perforations is arranged in a regular pattern having a horizontal repeat width of, for example, 0.36 inches. The plurality of perforations is arranged in a regular pattern and can have a vertical repeat height of, for example, 1.24 inches. In some examples, each perforation has a width of about 0.31 inches. In some implementations, the plurality of perforations each has a perforation width, the spaced relationship of the openings has a vertical spacing interval, and the vertical spacing interval is smaller than the perforation width. The plurality of perforations can be arranged in a diagonal pattern having a slope of, for example, 23 degrees with respect to vertical.

In some examples, the openings have a density of 1 percent of the screen surface, or about 0.009 square inches per square inch of screen. In other examples, the openings comprise from 0.5 percent to 2 percent of the screen surface. In some examples, the screen can include a metal sheet having a thickness of between 0.036 inches and 0.315 inch.

The present application is also directed to a cheese blockformer comprising a tower having a plurality of walls, each wall having an interior side that faces an interior volume of the tower; a first screen disposed inside the tower and parallel with the interior side of a first wall from among the plurality of walls, the screen having an exterior side facing the interior side of the first wall and an interior side facing the interior volume of the tower; and a plurality of openings in the screen, each opening comprising a perforation and a dimple, the dimple being disposed on the exterior side of the screen.

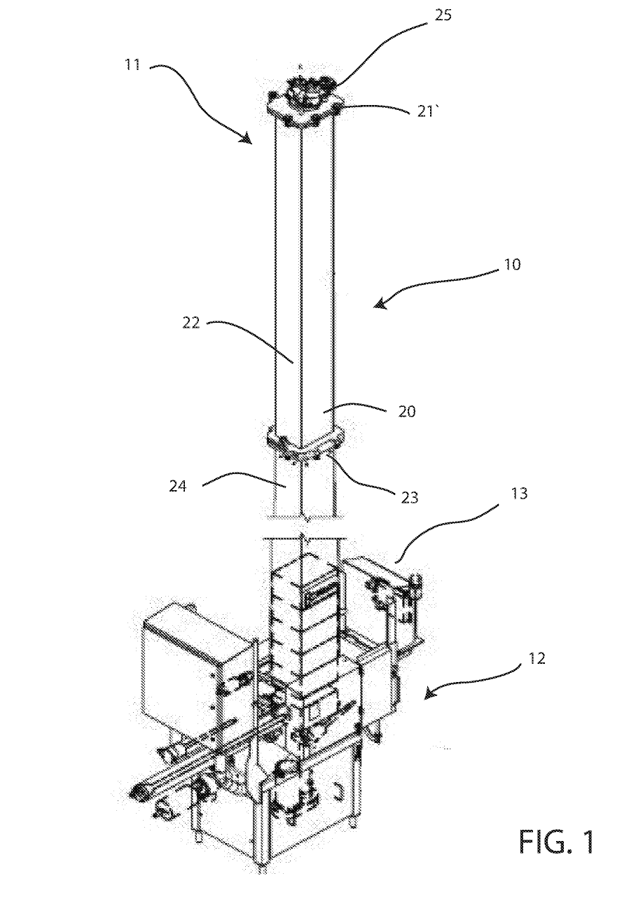

Now, in reference to the drawings, FIG. 1 is a perspective view of a cheese blockformer 10 constructed and arranged in accordance with the present disclosure. The blockformer 10 includes a tower column 20, made of a rigid material able to maintain and withstand an internal vacuum. In some examples, the tower column 20 is made from a metal such as stainless steel. In operation cheese curd travels from the top 11 to the bottom 13 of the tower column 20, having whey removed along the path. Blockformer 10 includes a curd injection assembly 25 at the top 11 of the blockformer 10, and a block processing assembly 12 at the bottom of the tower column 20. In the block processing assembly 12 the finished blocks of cheese are formed and cut to size. In the depicted example, the tower column 20 has an upper portion 22 and a lower portion 24, joined together at junction 23. Thus, in this construction the tower column 20 has two joined sections. It will be understood that in some constructions the tower column 20 is a single vertical section, while in other constructions the tower column 20 is formed of two or more vertical sections. FIG. 1 also shows a top flange 21 for joining the tower column 20 to additional components at the curd injection assembly 25.

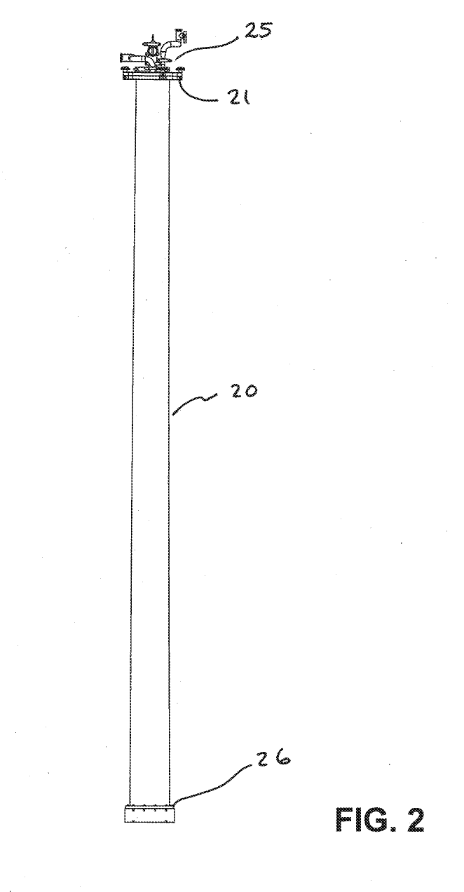

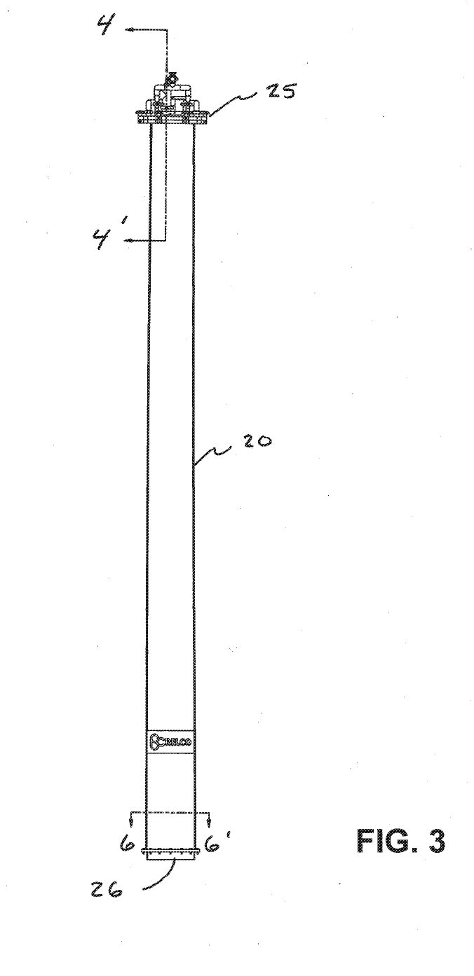

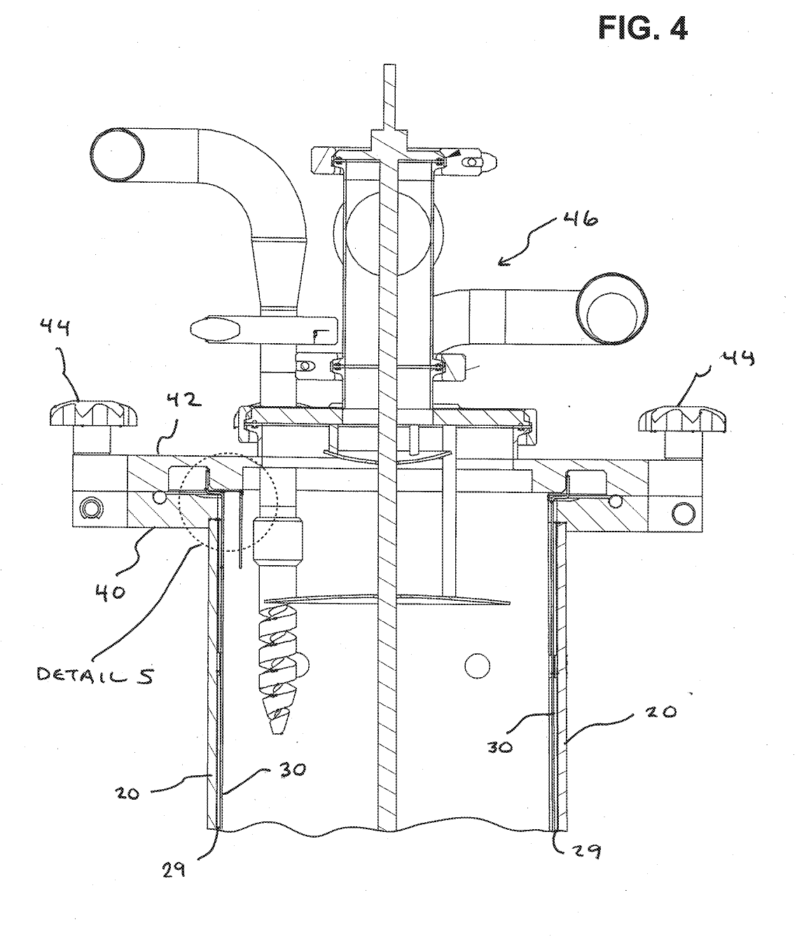

FIG. 2 is a side elevational view of the tower of a cheese blockformer, showing just the tower column 20 along with portions of the curd injection assembly 25 and the top flange 21. A bottom flange 26 is also shown, for securing the tower column 20 to the processing assembly 12 (shown in FIG. 1) FIG. 3 is a side elevational view of the tower column 20 of a cheese blockformer 10, showing the tower column of FIG. 2 but at a 90 degree rotated angle. Lines and arrows 4-4′ and 6-6′ show cross sections corresponding to FIGS. 4 and 6. FIG. 4 is a side cross sectional view of the top portion of a cheese blockformer 10 constructed and arranged in accordance with an implementation of the present disclosure. The top of the tower column 20 is shown, with a screen 30 positioned within the tower column 20. The screen 30 closely aligns with the interior of the tower column 20, but has a small interior gap 29 between the tower column 20 and the screen 30. This interior gap 29 is subject to a vacuum to draw liquid whey out of the cheese curd (not shown) and through the screen 30, as detailed below. The top of the tower column 20 is also shown with two flanges 40 and 42, joined together by fasteners 44. The fasteners 44 secure other aspects of a curd delivery system 46 to the top of the tower column 20.

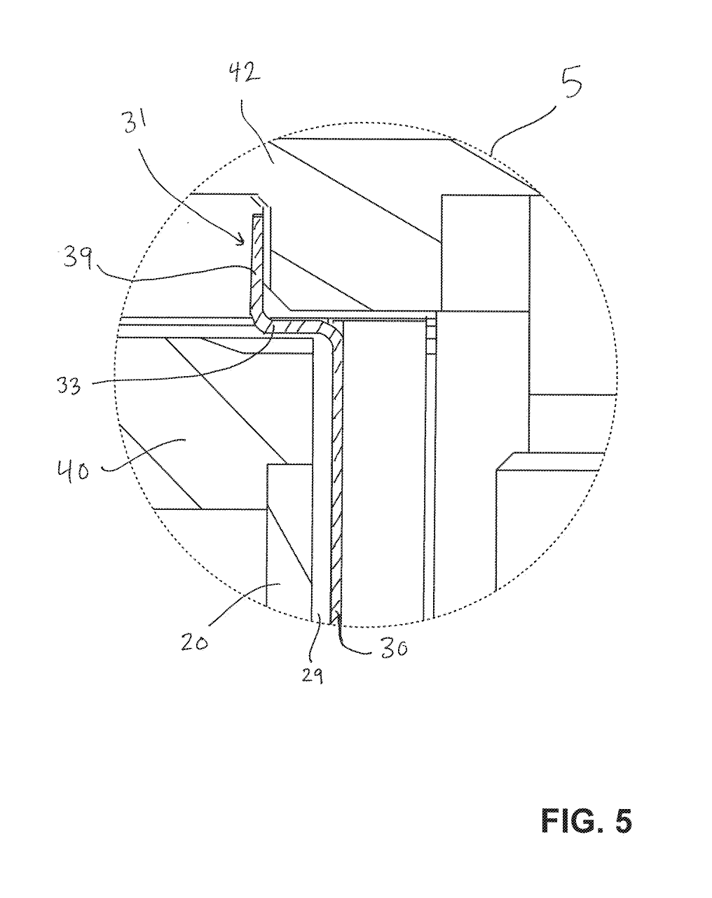

FIG. 5 is an enlarged side cross sectional view of a portion of the cheese blockformer of FIG. 4. The tower column 20, screen 30, interior gap 29, and flanges 40 and 42 are all depicted. The screen 30 is shown with a top end 31 with a lip comprising an outwardly extending portion 33 and an upwardly extending portion 39, which locks the screen in place upon securing the top and bottom flanges 40, 42 to one another. This design allows the screen 30 to be raised up from bottom of the tower column 20 and retained in place primarily by this top end 31 of the screen 30.

FIG. 6 is a top view of a cross section of the lower portion of the tower, showing a flange 27 with bolts 28. The interior gap 29 of the tower column 20 is shown, along with the screen 30 with interior surface 70 facing the interior volume of the tower column 20, and an exterior surface 72 facing the walls of the tower column 20.

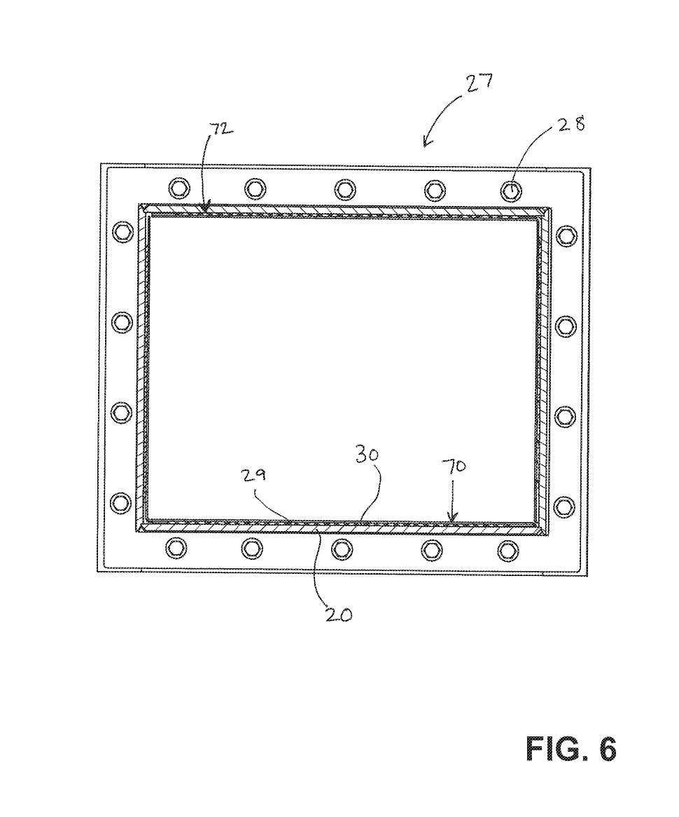

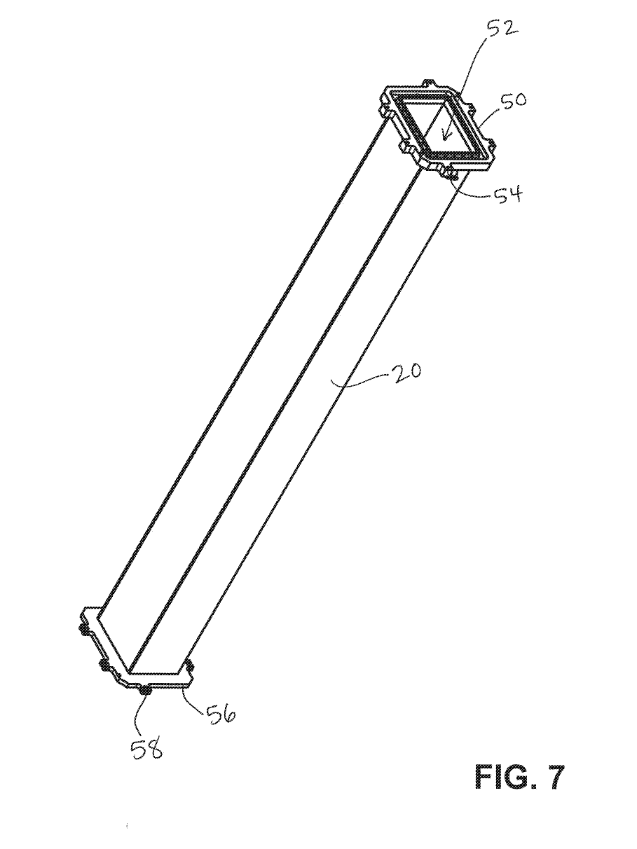

FIG. 7 is a perspective view of a tower column 20 of a cheese blockformer showing an interior volume 52 (into which a screen 30 is placed, so as to form a gap between the screen and tower column wall), plus a top flange 50 and a bottom flange 56, further comprising holes or openings 54 and 58 for securing the flanges either to other column sections or to the top or bottom portions of the blockformer assembly (such as to the equipment for delivering curd at the top of the column or equipment for cutting the cheese blocks at the bottom of the column).

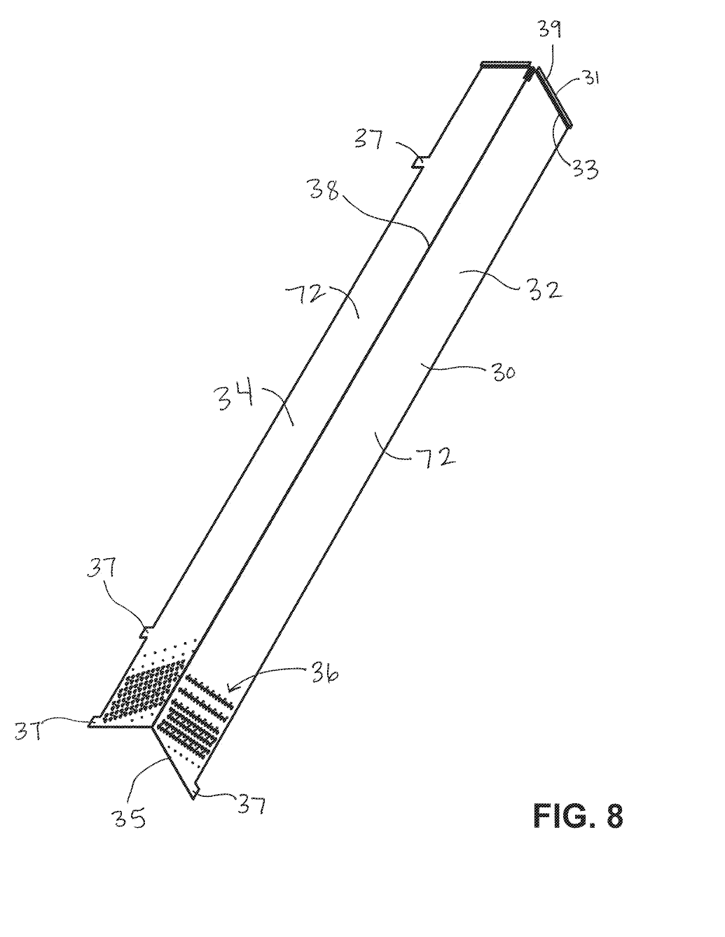

FIG. 8 is a perspective view of an example two-sided screen 30 for a cheese blockformer constructed and arranged in accordance with an implementation of the present disclosure. The view of FIG. 8 shows the exterior surface 72 of the screen. In operation, a pair of two of such screens 30 would be placed next to one another in a column tower to form a rectangular screen. Alternatively, it will be understood that instead of using a pair of two-sided screens a single four-sided screen can be used. Also, in the event the column is not rectangular, the screens can have a different shape corresponding to the column, such as circular.

In some cases, two pairs of these screens 30 are put in the tower column 20, such as when the tower column 20 is formed in two sections. Optionally three pairs of these screens 30 are arranged end to end in the tower column, such as when the tower column is formed in three sections. The screen 30 includes a first panel 32 and a second panel 34, joined by a fold line 38. The first panel 32 and second panel 34 are typically bent at a 90-degree angle to one another. The screen 30 has a top end 31 and a lower end 35. The top end 31 includes the outwardly bent portion 33 for resting on the top of the column (as shown and described with reference to FIG. 5).

The screen 30 has a plurality of openings 36 that provide drainage for removal of whey from the curd. In this figure, and others in this disclosure, a plurality of openings 36 are shown on just a part of each panel 32, 34, but typically the openings 36 are present on most, almost all, or all of the surface of the screen 30.

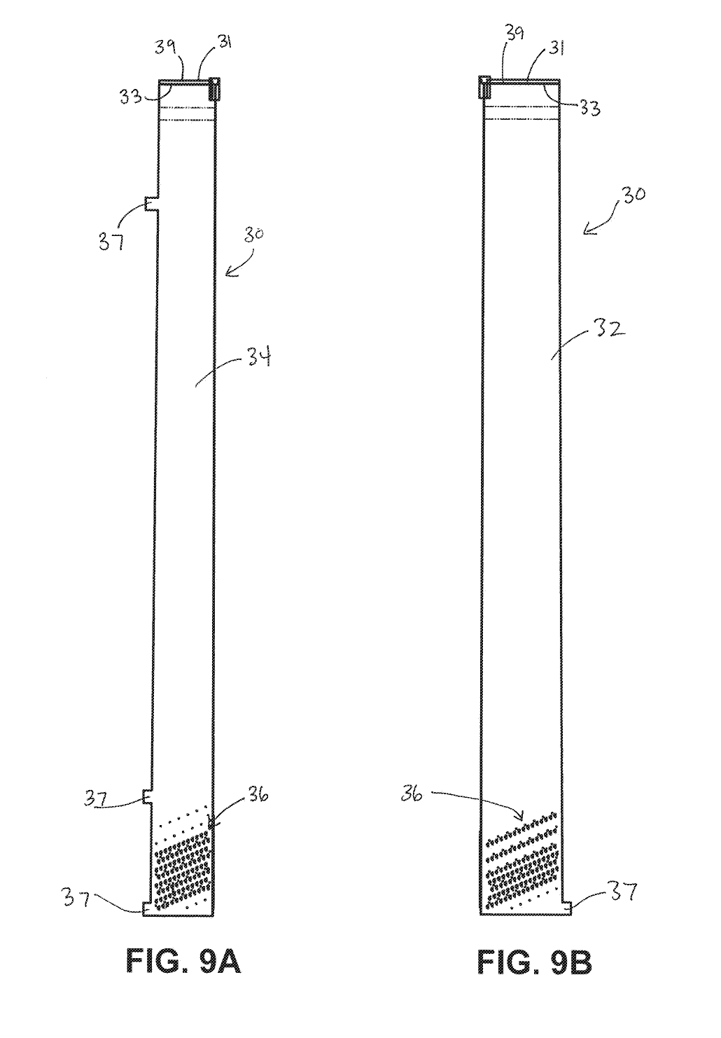

FIGS. 9A and 9B show two sides of the screen of FIG. 8. FIG. 9A is an elevational view of a first side of a two-sided screen for a cheese blockformer constructed and arranged in accordance with an implementation of the present disclosure. FIG. 9B is an elevational view of a second side of the two-sided screen for a cheese blockformer of FIG. 9A, constructed and arranged in accordance with an implementation of the present disclosure. The figures show the screen 30, as well as first panel 32 and second panel 34. The flange includes a top end 31 and a lower end 35. Although FIGS. 9A and 9B show the openings 36 in only a portion of the screen 30, it should be understood that the openings 36 can be present on most, almost all, or all of the surface of the screen 30.

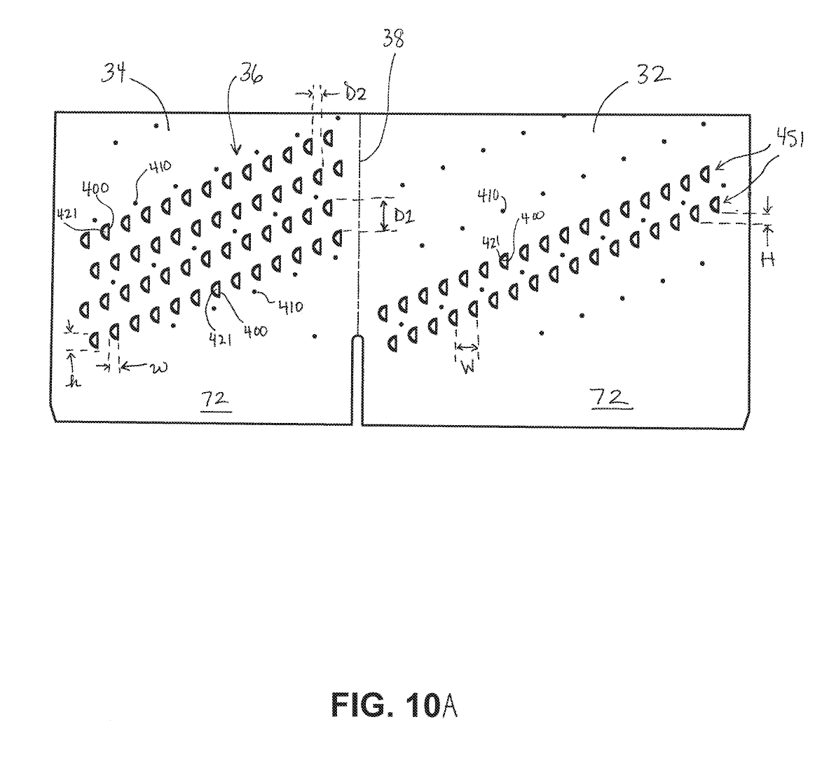

FIG. 10A is an elevational view of a perforated section of screen 30 for a cheese blockformer. Portions of panels 32 and 34 are shown, along with fold line 38. Openings 36 comprise perforations 400 with dimples 421. In the example of FIG. 10A, the dimples 421 are substantially semicircular or otherwise partially circular. Additional smaller circular openings 410 are also present in the example of FIG. 10A. Some examples of the disclosed technology include the circular openings 410, while other examples omit the smaller openings. In the example of FIG. 10A, the perforations 400 are substantially vertical with respect to the direction of flow of curd through the tower column 20.

In some examples, the screen 30 can include a metal sheet having a thickness of between about 0.036 inches and about 0.315 inches. The dimples 421 can be formed using metal punching, in which the screen 30 is pierced, and the perforation 400 and dimple 421 are forcibly deformed to create a recess and an opening.

As used herein, the area of the opening is defined as the amount of surface area of the screen 30 that is displaced when the perforation 400 and dimple 421 are punched. In some examples, the openings have an area of 1 percent of the screen surface area, or about 0.009 square inches of opening per square inch of screen in some configurations. In other examples, the area of the openings comprise from about 0.5 percent to about 2 percent of the screen surface area.

In some constructions, the perforations 400 are arranged in a regular pattern having a horizontal repeat width W, which is defined as the horizontal distance between a first perforation and a second perforation along a single diagonal row of dimples 421. The horizontal repeat width W can be at least 0.2 inches, at least 0.3 inches, at least 0.4 inches, at least 0.5 inches, or about 0.6 inches. In some examples, the horizontal repeat width W can be greater than 0.6 inches. In some examples, the horizontal repeat width W is less than 1.0 inches, less than 0.9 inches, less than 0.8 inches, less than 0.7 inches, less than 0.6 inches, less than 0.5 inches, less than 0.4 inches, or less than 0.3 inches. In one non-limiting example, the horizontal repeat width W is about 0.72 inches.

The perforations 400 also have a vertical repeat height H, which is defined as the vertical distance between the bottom of a first perforation and the bottom of a second perforation along a single diagonal row of dimples 421. In some examples, the vertical repeat height H is at least 0.7 inches, at least 0.8 inches, at least 0.9 inches, at least 1.0 inch, at least 1.1 inches, at least 1.2 inches, at least 1.3 inches, at least 1.4 inches, or at least 1.5 inches. In some examples, the vertical repeat height H is at most 2.0 inches, at most 1.9 inches, at most 1.8 inches, at most 1.7 inches, at most 1.6 inches, at most 1.5 inches, at most 1.4 inches, at most 1.3 inches, at most 1.2 inches, at most 1.1 inches, or at most 1.0 inches. In one non-limiting example, the vertical repeat height H is approximately 1.24 inches.

Each dimple 421 has a dimple width w. In some examples, the dimple width w can be at least 0.1 inches, at least 0.2 inches, at least 0.3 inches, at least 0.4 inches, at least 0.5 inches, or at least 0.6 inches. In some examples, the dimple width w is at most 0.7 inches, at most 0.6 inches, at most 0.5 inches, at most 0.4 inches, at most 0.3 inches, or at most 0.2 inches. In one non-limiting example, the dimple width w can be about 0.31 inches.

Each perforation 400 has a perforation height h. In some examples, the perforation height h can be at least 0.1 inches, at least 0.2 inches, at least 0.3 inches, at least 0.4 inches, at least 0.5 inches, or at least 0.6 inches. In some examples, the perforation height h can be at most 0.7 inches, at most 0.6 inches, at most 0.5 inches, at most 0.4 inches, at most 0.3 inches, or at most 0.2 inches. In one non-limiting example, the perforation height h can be about 0.56 inches.

In some implementations, the perforations 400 have a perforation height, the spaced relationship of the openings has a vertical repeat height, and the vertical repeat height is smaller than the perforation height.

The diagonal rows of perforations have an offset height D1, which is defined as the vertical distance between the top of a perforation on a first diagonal row and the top of the nearest perforation on an immediately adjacent row. In some examples the offset height D1 is at least 0.7 inches, at least 0.8 inches, at least 0.9 inches, at least 1.0 inches, at least 1.1 inches, at least 1.2 inches, at least 1.3 inches, at least 1.4 inches, or at least 1.5 inches. In some examples, the offset height D1 is at most 1.7 inches, at most 1.6 inches, at most 1.5 inches, at most 1.4 inches, at most 1.3 inches, at most 1.2 inches, at most 1.1 inches, at most 1.0 inches, or at most 0.9 inches. In one non-limiting example, the offset height D1 is about 1.1 inches.

The diagonal rows of perforations have an offset width D2, which is defined as the horizontal distance between a perforation on a first diagonal row and the nearest perforation on an immediately adjacent row. In some examples, the offset width D2 can be at least 0.1 inches, at least 0.2 inches, at least 0.3 inches, at least 0.4 inches, at least 0.5 inches, or at least 0.6 inches. In some examples, the offset width D2 can be at most 0.7 inches, at most 0.6 inches, at most 0.5 inches, at most 0.4 inches, at most 0.3 inches, or at most 0.2 inches. In one non-limiting example, the offset width D2 is about 0.36 inches.

The perforations 400 can be arranged in diagonal rows 451. In some examples, the diagonal rows 451 have a slope of at least 10 degrees, at least 20 degrees, at least 30 degrees, at least 40 degrees, at least 50 degrees, or at least 60 degrees. In some examples, the diagonal rows 451 have a slope of at most 70 degrees, at most 60 degrees, at most 50 degrees, at most 40 degrees, at most 30 degrees, or at most 20 degrees. In one non-limiting example, the diagonal rows 451 have a slope of about 23 degrees.

FIG. 10B is an elevational view of an alternative example of a perforated portion of a screen for a tower column of a cheese blockformer. In the example of FIG. 10B, the screen 30 has a plurality of openings 36′ comprising perforations 400′ and dimples 421′. In the view of FIG. 10 B, dimple 421′ is viewed from the perspective of the interior volume of the screen, where the interior surface 70 can be seen. From this vantage, the dimple 421′ appears as a depression in the interior surface 70. The arrow 1141 indicates a direction of flow of the curd through the tower column, and can be various angles. In the example of FIG. 10B, each perforation 400′ is substantially linear. However, in contrast to the example of FIG. 10A, each perforation 400′ in FIG. 10B is angled with respect to the direction of curd flow. The angle θ of the perforation 400′ is non-vertical. In some examples, the angle θ is greater than zero degrees. In some examples, the angle θ is less than 180 degrees. In some examples, the angle θ is between 5 degrees and 85 degrees, between 10 degrees and 80 degrees, between 20 degrees and 70 degrees, between 30 degrees and 60 degrees, or between 40 degrees and 50 degrees. In some examples, the angle θ is approximately 10 degrees, approximately 20 degrees, approximately 30 degrees, approximately 40 degrees, approximately 45 degrees, approximately 50 degrees, approximately 60 degrees, approximately 70 degrees, approximately 80 degrees, or approximately 90 degrees. In some examples, the angle θ is between 90 degrees and 170 degrees.

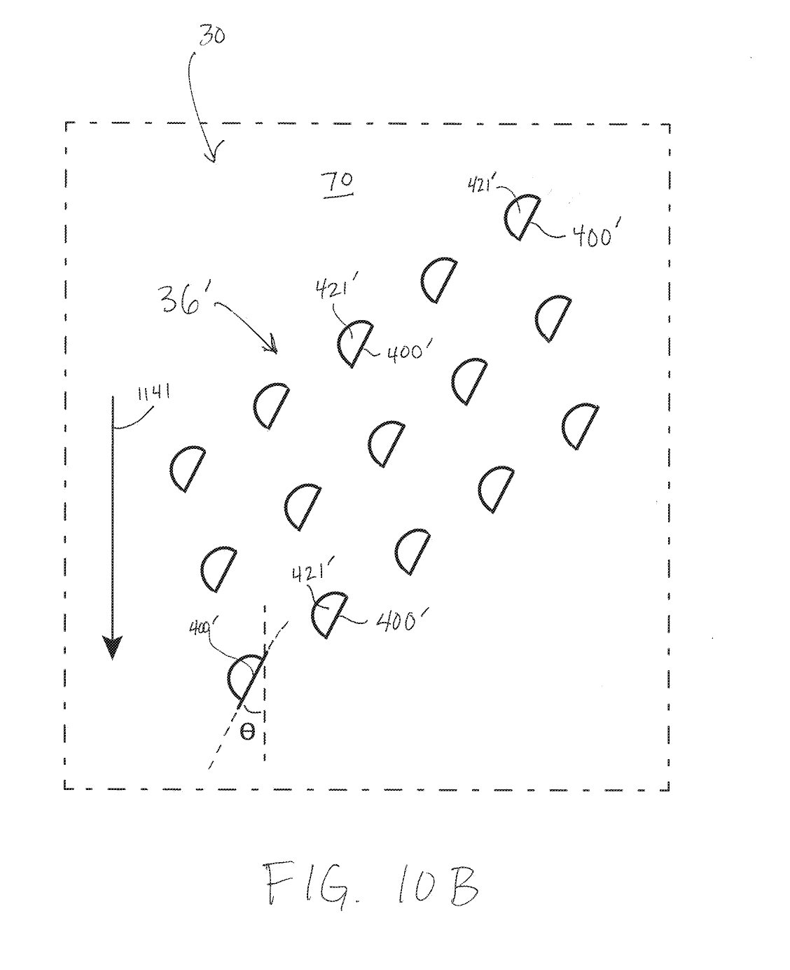

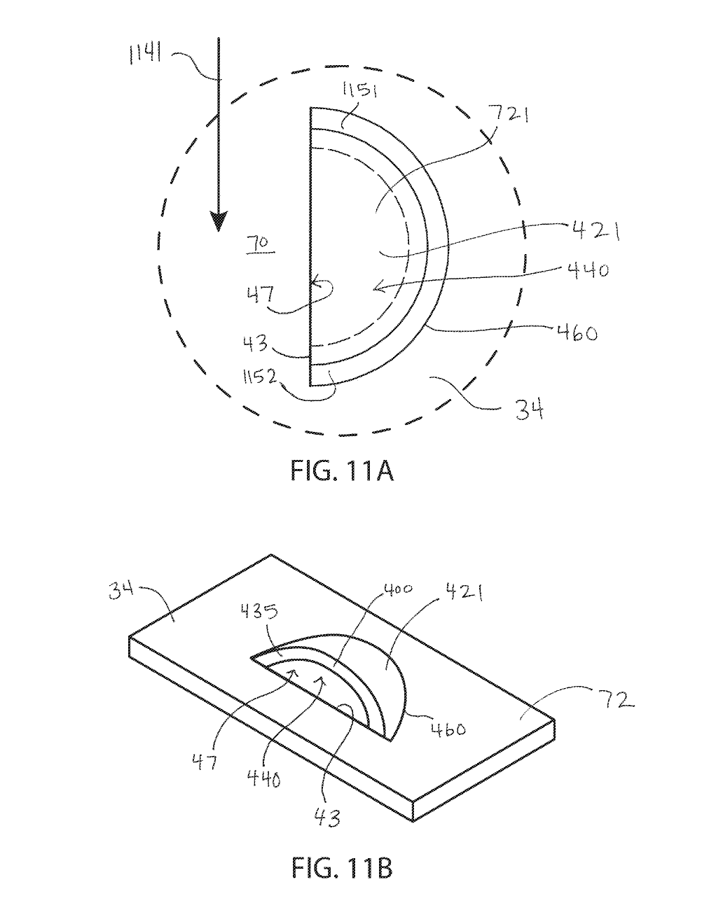

FIGS. 11A and 11B are respectively an enlarged side elevational and perspective view of a perforation 400 in a screen 30 for a cheese blockformer. In the view of FIG. 11A, dimple 421 is viewed from the perspective in the interior volume of the screen, where the interior surface 70 can be seen. From this vantage, the dimple 421 appears as a depression in the interior surface 70.

In FIG. 11A, the direction of flow of the curd in relation to the perforation 400 is demonstrated by arrow 1141, and is typically from 0 to 90 degrees. As curd flows along the interior surface 70 of the screen 30 in the direction of flow, the curd first encounters a first inclined surface 1151 at the upstream side of the dimple 421, which is inclined away from the curd. As the curd continues to flow, it encounters a second inclined surface 1152 at the downstream side of the dimple 421, which is inclined toward the interior surface 70 of the screen 30.

In the view of FIG. 11B, dimple 421 is viewed from the perspective of the exterior of the screen 30, where the exterior surface 72 can be seen. In this view, the dimple 421 appears as an elevated portion in the panel 34. An opening 47 allows liquid whey and air to escape from the interior of the tower into the interior gap 29 between the screen 30 and the tower column 20.

The perforation 400 is defined by a screen edge 43 and a dimple edge 435, which in turn defines the opening 47 in the screen 30. In the example of FIGS. 11A and 11B, the screen edge 43 is generally linear. A perimeter 460 of the dimple 421 abuts the panel 34 exterior surface 72. The dimple 421 defines a recess 440. The perimeter 460 of the dimple or louver 421 of perforation 400 has a smooth transition to the surrounding panel 34.

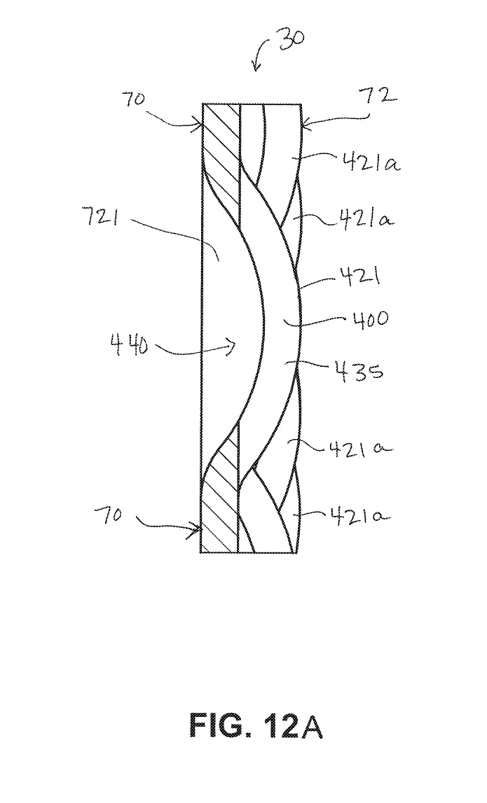

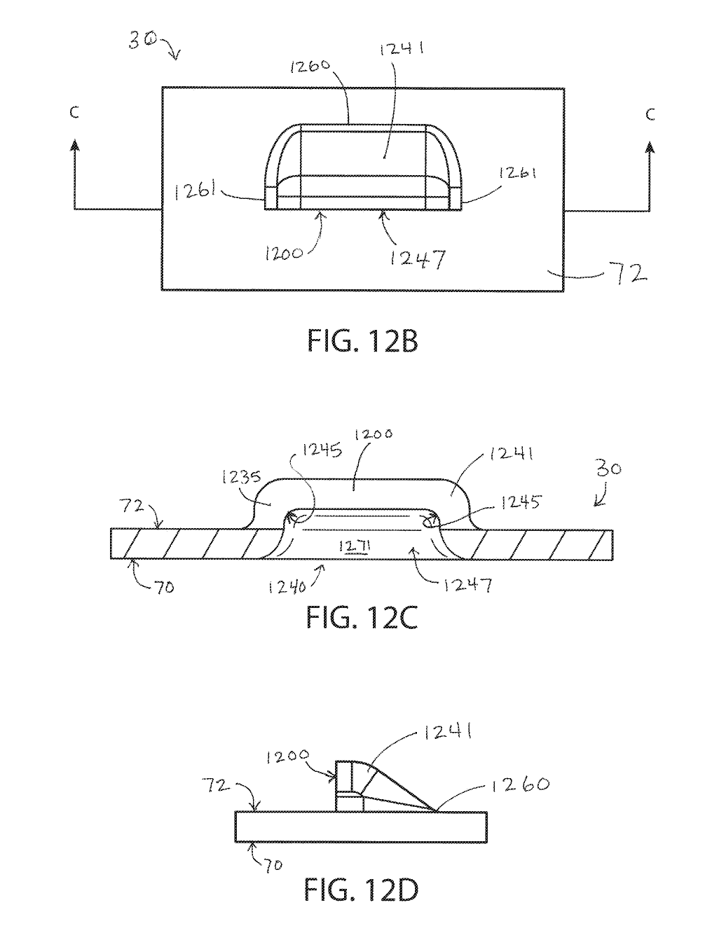

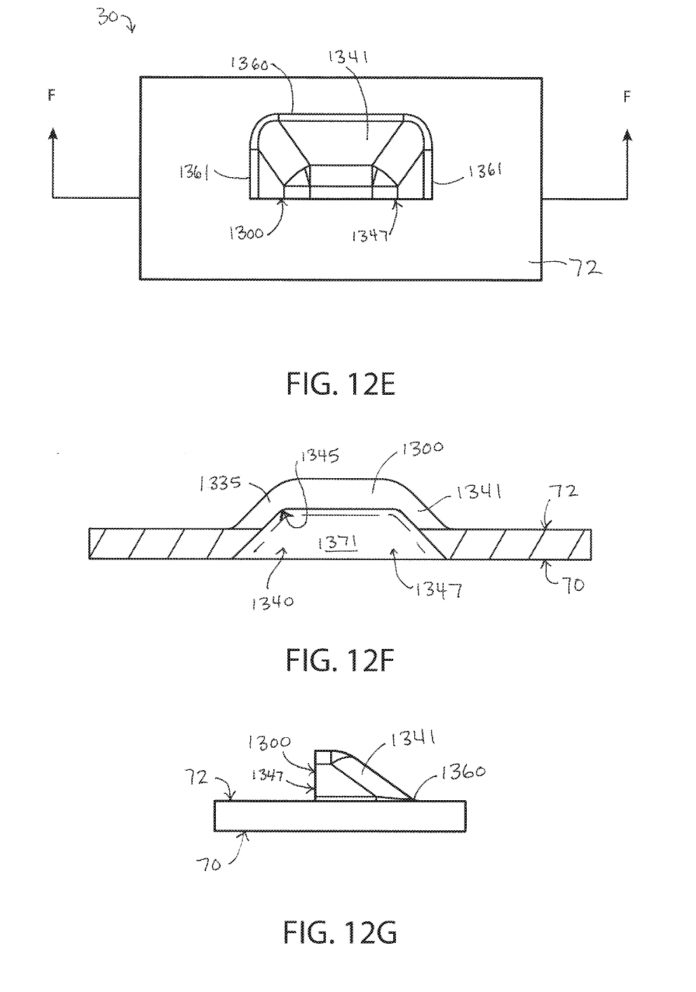

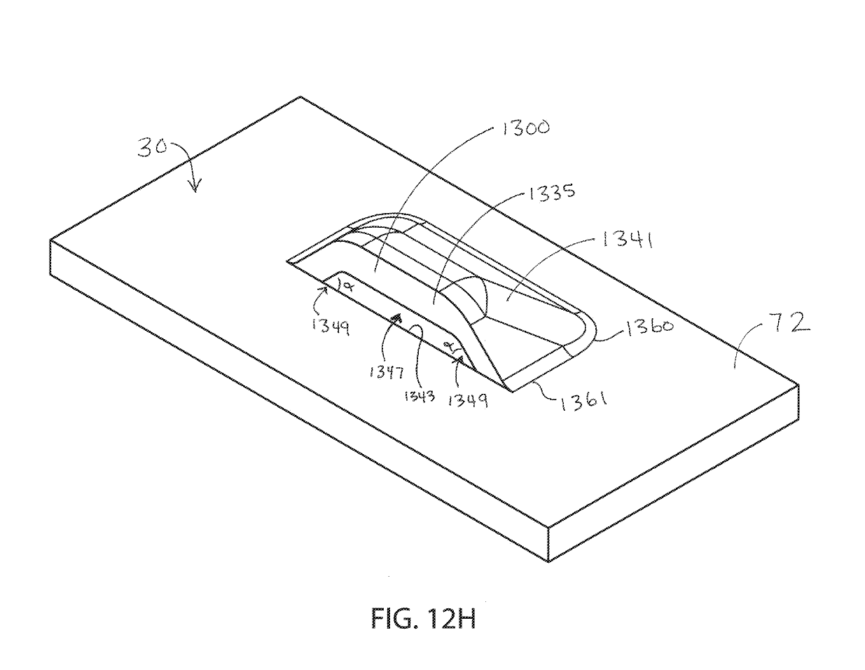

FIG. 12A is a side cross-sectional view of a perforation 400 in a screen 30 for a cheese blockformer, showing an interior surface 70 and exterior surface 72 of the screen 30. A first dimple 421 is shown, with additional dimples 421a shown behind this dimple 421. An interior dimple wall 721 bounds the recess 440 of the dimple 421.

FIG. 12B is a side elevation view of an alternative example of a perforation in a screen 30 for a tower column 20 of a cheese blockformer. In the example of FIG. 12B, a dimple 1241 having a perforation 1200 is shown. An opening 1247 allows liquid whey and air to escape from the interior of the tower column into the interior gap 29 between the screen 30 and the tower column 20. The dimple 1241 is defined by a perimeter 1260. As drawn, cheese flow is generally from top to bottom of FIG. 12B, but it will be appreciated that it can be in various directions depending upon how the dimple 1241 is oriented.

FIG. 12C is a cross-sectional view taken along line C-C of the alternative example of FIG. 12B, and FIG. 12D is a bottom view of the alternative example of FIG. 12B. As shown in FIG. 12C, the dimple 1241 has a dimple edge 1235 that partially defines the opening 1247. A recess 1240 in the dimple 1241 is bounded by an interior dimple wall 1271. Unlike the semicircular dimple 421 of FIGS. 11A-B, the dimple 1241 shown in FIGS. 12B-D have a rectangular perimeter 1260 with a plurality of partially straight sides 1261. The perforation 1200 has a dimple edge 1235 with multiple corners 1245.

FIG. 12E is a side elevation view of another alternative example of a perforation in a screen for a tower column of a cheese blockformer. In the example of FIG. 12E, a dimple 1341 having a perforation 1300 is shown. An opening 1347 allows liquid whey and air to escape from the interior of the tower column into the interior gap 29 between the screen 30 in the tower column 20. The dimple 1341 is defined by a perimeter 1360. As drawn, cheese flow is generally from top to bottom of FIG. 12E, but it will be appreciated that it can be in various directions depending upon how the dimple 1341 is oriented.

FIG. 12F is a cross-sectional view taken along line F-F of the alternative example of FIG. 12E, and FIG. 12G is a bottom view of the alternative example of FIG. 12E. The dimple 1341 has a dimple edge 1335 that partially defines the opening 1347. A recess 1340 in the dimple 1341 is bounded by an interior dimple wall 1371. Unlike the semicircular dimple 421 of FIGS. 11A-B, the dimple 1341 shown in FIGS. 12E-G has a partially rectangular perimeter 1360 with a plurality of straight sides 1361. The perforation 1300 has a dimple edge 1335 with multiple corners 1345. As will be discussed further with relation to FIG. 12 H, the dimple 1341 has straight sidewalls that define an internal angle with the surface of the screen 30.

FIG. 12H is a perspective view of the alternative example of FIG. 12E. The dimple 1341 defines an opening 1347 bounded by the perforation 1300 having a dimple edge 1335 and a screen edge 1343. The screen edge 1343 meets the dimple edge 1335 at the corners of the opening 1347, forming internal opening angles α.

Some types of cheeses contain condiments or small pieces of chopped food. For example, pepper jack cheese can contain chopped pieces of jalapeno peppers. Curd that is to be made into pepper jack cheese contains the chopped peppers. These food pieces can become caught in the interior corners 1349 of the opening 1347. This is undesirable, because remaining food pieces can be unsanitary and because leftover food pieces retained in the interior corners 1349 can later contaminate curd that is not intended to have the food pieces. Choosing an appropriate internal opening angle α can prevent this situation. In some examples, the internal opening angle α is at least 10 degrees. In some examples, the internal opening angle α is about 90 degrees. In some examples, the internal opening angle α is less than 90 degrees, less than 80 degrees, less than 70 degrees, less than 60 degrees, less than 50 degrees, less than 40 degrees, less than 30 degrees, or less than 20 degrees. In some examples, the internal opening angle α is greater than 20 degrees, greater than 30 degrees, greater than 40 degrees, greater than 50 degrees, greater than 60 degrees, greater than 70 degrees, or greater than 80 degrees. In some examples, the internal opening angle α is between about 20 degrees and about 80 degrees, between about 30 degrees and about 70 degrees, between about 40 degrees and about 60 degrees, or between about 45 degrees and 55 degrees.

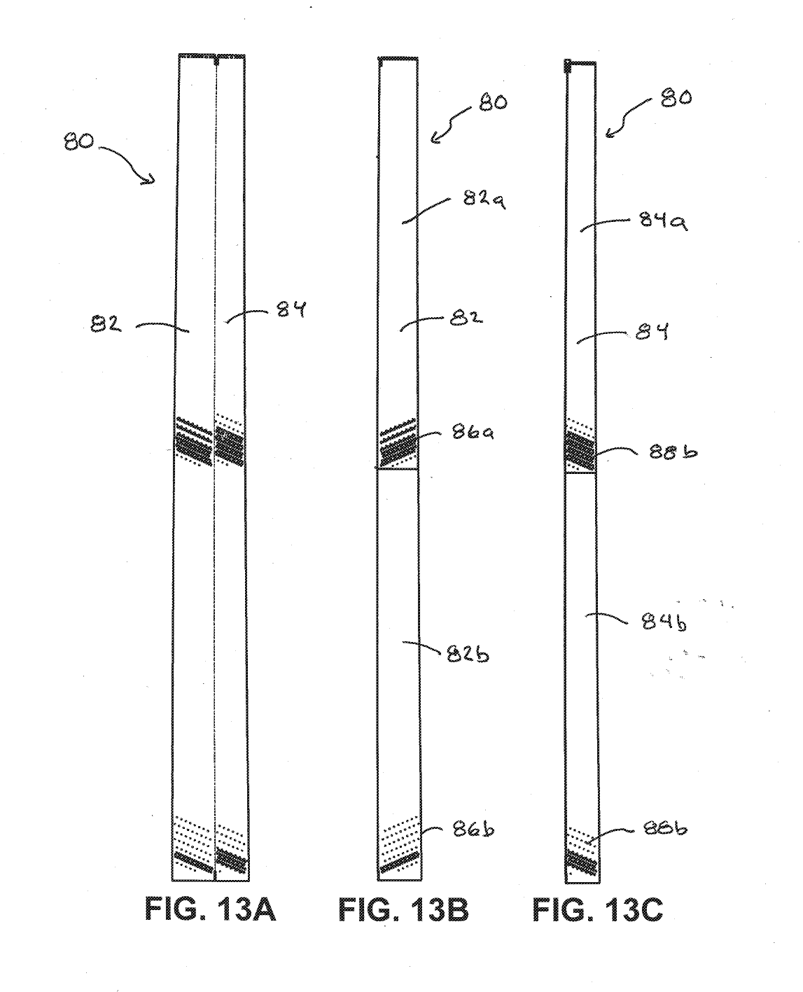

FIG. 13A is an elevational view of a screen 80 for a cheese blockformer, before the screen 80 is folded into an approximately 90-degree angle. FIG. 13B is an elevational view of a first panel 82 of the screen 80 for a cheese blockformer of FIG. 13A constructed and arranged in accordance with an implementation of the present disclosure. FIG. 13C is an elevational view of a second panel 84 of the screen 80 for a cheese blockformer of FIG. 13A, constructed and arranged in accordance with an implementation of the present disclosure. The first and second panels each contain upper sections 82a and 84a, and lower sections 82b and 84b. Each screen also has two areas of perforations: 86a and 86b, and 88a and 88b.

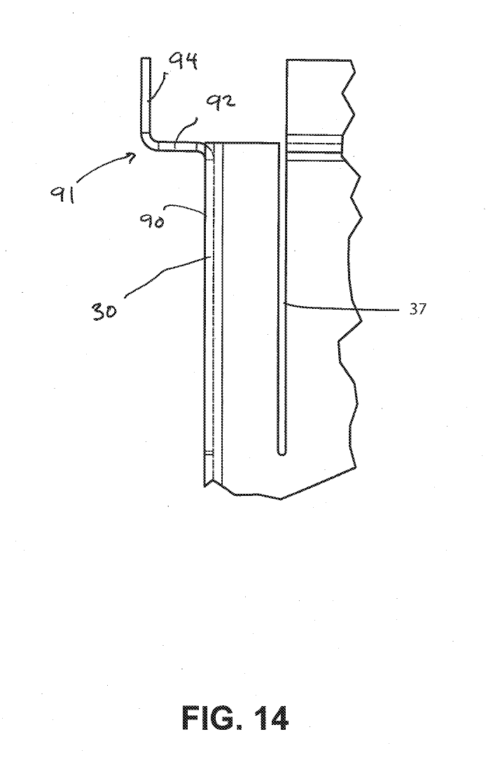

FIG. 14 is a closeup of the top of a screen for a cheese blockformer, showing a lower portion 90, plus an upper portion 91 having an outward portion 92 and upward portion 94. The upper portion 91 allows the screen 30 to be aligned within the column tower (not shown) by having the outward portion 92 engage the top of the column to control the depth of the screen, while the upward portion 94 engages the top of the column to help control the horizontal position of the screen 30 and to aid in removal of the screen. The outward portion 92 is able to transfer the significant downward forces from the moving curd to the column in a relatively uniform manner, providing a durable and strong (yet readily serviceable) connection between the screen and tower column. Slots 37 shown in the figure allow side edges 91, 92, 94 to bend inward sufficiently to allow these elements to pass through the outer shell wall.

While the invention has been particularly shown and described as referenced to the embodiments thereof, those skilled in the art will understand that the foregoing and other changes in form and detail may be made therein without departing from the spirit and scope of the invention.

What is claimed is:

1. A screen for a cheese blockformer, the screen comprising:
a metal sheet having a vertical orientation; and
a plurality openings in the metal sheet, the openings each comprising a hemispherical perforation.

2. The cheese blockformer screen of claim 1, further comprising a raised dimple corresponding to each of the openings.

3. The cheese blockformer screen of claim 2, wherein the raised dimple forms the back of the hemispherical or curved shape perforation.

4. The cheese blockformer screen of claim 1, wherein the plurality of the openings in the metal sheet are diagonally offset.

5. The cheese blockformer screen of claim 1, wherein the hemispherical perforation comprises a substantially straight side and a substantially curved side, the straight side forming a break in the metal sheet, the curved side forming a continuous connection with the metal sheet.

6. The cheese blockformer screen of claim 1, wherein the hemispherical perforation is oriented such that a straight side is positioned in a substantially vertical orientation.

7. The cheese blockformer screen of claim 1, wherein the hemispherical vertical perforation forms incline from the upstream side of the screen.

8. The cheese blockformer screen of claim 1, wherein the hemispherical perforation forms an incline from the upstream side of the screen.

9. The cheese blockformer screen of claim 1, wherein the hemispherical perforation is semicircular.

10. The cheese blockformer screen of claim 1, wherein the hemispherical perforation is a partial circle.

11. The cheese blockformer screen of claim 1, further comprising circular openings disposed in the metal sheet between the hemispherical perforations.

12. The cheese blockformer screen of claim 1, wherein the plurality of hemispherical perforations is arranged in a regular pattern having a horizontal repeat width of 0.25 to 0.5 inches.

13. The cheese blockformer screen of claim 1, wherein the plurality of hemispherical perforations is arranged in a regular pattern having a vertical repeat height of 1 to 1.5 inches.

14. The cheese blockformer screen of claim 1 wherein the plurality hemispherical perforations have a perforation width, the spaced relationship of the openings has a vertical spacing interval, and wherein the vertical spacing interval is smaller than the perforation width.

15. The cheese blockformer screen of claim 1, wherein the plurality of hemispherical perforations comprises from 0.5 percent to 2 percent of the screen surface.

16. The cheese blockformer screen of claim 1, in a one-piece or two-piece construction.

17. A cheese blockformer comprising:
a column tower having a plurality of walls, each wall having an interior side that faces an interior volume of the tower;
a first screen disposed inside the tower and parallel with the interior side of a first wall from among the plurality of walls, the screen having an exterior side facing the interior side of the first wall and an interior side facing the interior volume of the tower; and
a plurality of openings in the screen, each opening comprising a dimple disposed on the exterior surface of the screen.

18. The cheese blockformer of claim 17, wherein the plurality of openings in the screen each comprise a vertical perforation.

19. The cheese blockformer of claim 17, wherein the dimple of each of the plurality of openings defines an internal angle of between 30 degrees and 90 degrees.

20. A cheese blockformer comprising:
a tower having a plurality of walls;
a first screen disposed inside the tower, the screen having an interior side facing an interior volume of the tower; and
a lip for engaging the top of the tower.
